(19) United States
(12) Patent Application Publication
(10) Pub. No.: US 2026/0098369 A1
(43) Pub. Date: Apr. 9, 2026

(54) WASHING MACHINE APPLIANCE OBJECT DETECTION

(71) Applicant: Haier US Appliance Solutions, Inc., Wilmington, DE (US)

(72) Inventor: Tanner Davis Gunn, Louisville, KY (US)

(21) Appl. No.: 18/908,981

(22) Filed: Oct. 8, 2024

(51) Int. Cl. D06F 34/14; D06F 23/02; D06F 33/32; D06F 34/20; D06F 37/26; D06F 103/40; D06F 105/50; D06F 105/58; D06F 105/62; G06V 20/50

(52) U.S. Cl. CPC D06F 34/14; D06F 23/02; D06F 33/32; D06F 34/20; D06F 37/266; G06V 20/50; D06F 2103/40; D06F 2105/50; D06F 2105/58; D06F 2105/62

(57) ABSTRACT

A method of operating a washing machine appliance includes obtaining one or more images with a camera assembly of the washing machine appliance. The one or more images may be obtained before or after an operation cycle of the washing machine appliance. One or more foreign objects on or in a gasket of the washing machine appliance may be detected by analyzing the one or more images.

### FIELD

The present subject matter relates generally to washing machine appliances, such as horizontal axis washing machine appliances, to gaskets for such washing machine appliances, and to systems and methods for using a camera assembly to facilitate monitoring for foreign objects in such appliances, e.g., in a door gasket thereof.

### BACKGROUND

Washing machine appliances generally include a cabinet which receives a wash tub for containing water or wash fluid (e.g., water and detergent, bleach, or other wash additives). The wash tub may be suspended within the cabinet by a suspension system to allow some movement relative to the cabinet during operation. A basket is rotatably mounted within the wash tub and defines a wash chamber for receipt of articles for washing. During normal operation of such washing machine appliances, the wash fluid is directed into the wash tub and onto articles within the wash chamber of the basket. A drive assembly is coupled to the wash tub and configured to rotate the wash basket within the wash tub to agitate articles within the wash chamber, to wring wash fluid from articles within the wash chamber, etc.

The basket may be accessible through an opening in the cabinet. A door may be hingedly mounted to the cabinet at the opening for rotating between an open position and a closed position. The door generally sealingly encloses the opening of the cabinet when the door is in the closed position. Such sealing enclosure may be aided by a gasket positioned at the opening which engages the door when the door is in the closed position. The gasket must accommodate relative movement, e.g., of the tub and/or basket relative to the door and/or cabinet. Generally, such gaskets may be folded over on themselves to allow for such relative movement. However, this folding typically creates an at least partly enclosed gutter portion within the gasket, such that foreign objects may become entrapped therein, and the presence of such objects may interfere with or damage the gasket. The at least partial enclosure of the gutter portion of the gasket may make observation and detection of such objects difficult.

Accordingly, features for detection of objects in or on a gasket of a washing machine appliance would be desirable.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a washing machine appliance is provided. The washing machine appliance includes a cabinet, a door rotatably mounted to the cabinet, a gasket, and a camera assembly. The method includes performing an operation cycle of the washing machine appliance. The operation cycle includes treating one or more articles in a wash chamber of the washing machine appliance. The method also includes obtaining an image with the camera assembly after performing the operation cycle. The image includes at least a portion of the gasket. The method further includes detecting one of the articles in or on the gasket based on the obtained image. The method also includes providing a user notification on a user interface of the washing machine appliance in response to the detected article.

In another exemplary embodiment, a method of operating a washing machine appliance is provided. The washing machine appliance includes a cabinet, a door rotatably mounted to the cabinet, a gasket, and a camera assembly. The method includes obtaining an image with the camera assembly. The image includes at least a portion of the gasket. The method also includes detecting a foreign object in or on the gasket based on the obtained image. The method further includes providing a user notification on a user interface of the washing machine appliance in response to the detected foreign object. The method also includes receiving an input via the user interface of the washing machine appliance. The input is responsive to the user notification. The method further includes activating the washing machine appliance in response to the input. Activating the washing machine appliance includes performing an operation cycle of the washing machine appliance.

In another exemplary embodiment, a washing machine appliance is provided. The washing machine appliance includes a cabinet, a door rotatably mounted to the cabinet, a gasket, a camera assembly, and a controller. The controller is configured for performing an operation cycle of the washing machine appliance. The operation cycle includes treating one or more articles in a wash chamber of the washing machine appliance. The controller is also configured for obtaining an image with the camera assembly after performing the operation cycle. The image includes at least a portion of the gasket. The controller is further configured for detecting one of the articles in or on the gasket based on the obtained image and providing a user notification on a user interface of the washing machine appliance in response to the detected article.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to exemplary embodiments of the present disclosure.

FIG. 2 provides a transverse cross-sectional view of the exemplary washing machine appliance of FIG. 1.

FIG. 3 provides a perspective view looking up at a portion of the exemplary washing machine appliance of FIG. 1 with a door thereof removed to more clearly illustrate additional components.

FIG. 4 provides a section view through an upper portion of a gasket for a washing machine appliance such as the washing machine appliance of FIG. 1.

FIG. 5 illustrates an exemplary image that may be obtained with a camera assembly in a washing machine appliance such as the washing machine appliance of FIG. 1.

FIG. 6 provides a perspective view looking down at a portion of the exemplary washing machine appliance of FIG. 1 with a door thereof removed and with various exemplary articles or foreign objects proximate to a gasket of the washing machine appliance.

FIG. 7 provides a section view through a portion of an exemplary washing machine appliance such as the washing machine appliance of FIG. 1 with various exemplary articles or foreign objects proximate to a gasket thereof.

FIG. 8 provides a diagrammatic illustration of a washing machine appliance in communication with a remote computing device and with a remote user interface device according to one or more exemplary embodiments of the present subject matter.

FIG. 9 provides a flow diagram of an exemplary method for operating a washing machine appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

Directional terms such as “left” and “right” are used herein with reference to the perspective of a user standing in front of a household appliance to access the appliance and/or items therein. Terms such as “inner” and “outer” refer to relative directions with respect to the interior and exterior of the appliance. For example, “inner”or “inward”refers to the direction towards the interior of the appliance. Terms such as “left,” “right,” “front,” “back,” “top,” or “bottom” are used with reference to the perspective of a user accessing the appliance. For example, a user stands in front of the appliance to open the door(s) and reaches into the appliance to add, move, or withdraw items therein.

As used herein, the terms “first,” “second,” and “third” may be used interchangeably to distinguish one component from another and are not intended to signify location or importance of the individual components. As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

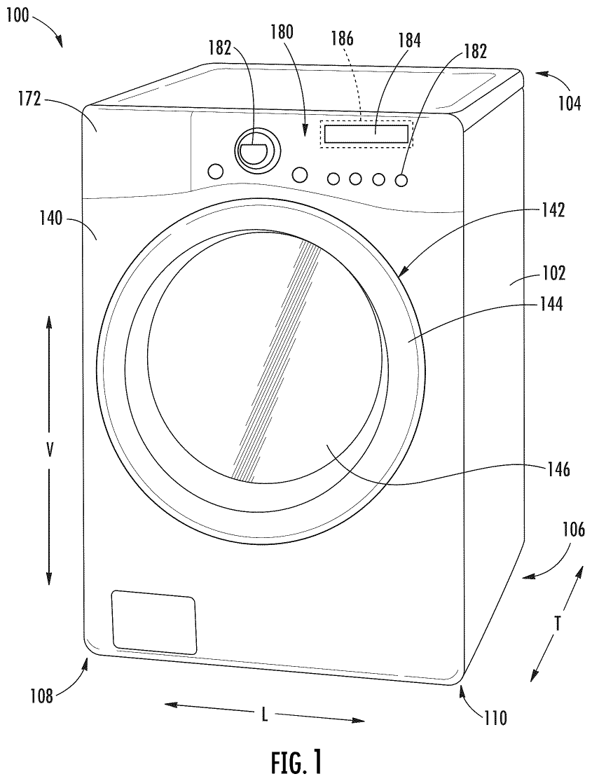

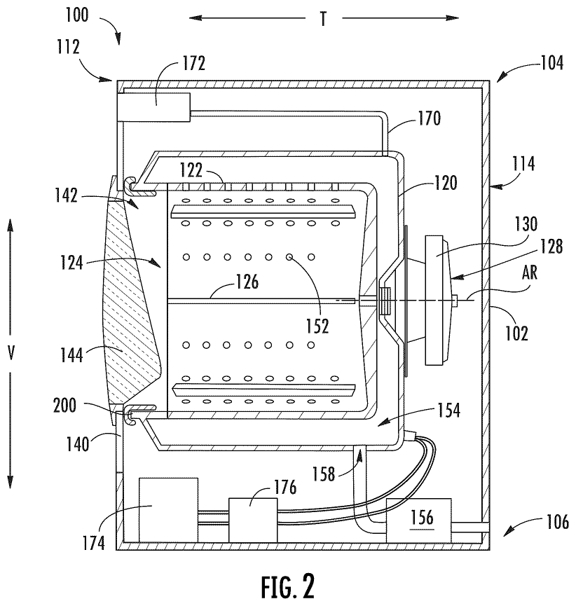

Referring now to the figures, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction L, and between a front 112 and a rear 114 along the transverse direction T.

Referring to FIG. 2, a wash tub 120 is positioned within cabinet 102 and is generally configured for retaining wash fluids during an operating cycle. As used herein, “wash fluid” may refer to water, detergent, fabric softener, bleach, or any other suitable wash additive or combination thereof. A wash basket 122 is received within wash tub 120 and defines a wash chamber 124 that is configured for receipt of articles for washing. More specifically, wash basket 122 is rotatably mounted within wash tub 120 such that it is rotatable about an axis of rotation AR. According to the illustrated embodiment, the axis of rotation is substantially parallel to the transverse direction T. In this regard, washing machine appliance 100 is generally referred to as a “horizontal axis” or “front load” washing machine appliance 100. However, it should be appreciated that aspects of the present subject matter may be used within the context of a vertical axis or top load washing machine appliance as well.

Wash basket 122 may define one or more agitator features that extend into wash chamber 124 to assist in agitation and cleaning articles disposed within wash chamber 124 during operation of washing machine appliance 100. For example, as illustrated in FIG. 2, a plurality of ribs 126 extends from basket 122 into wash chamber 124. In this manner, for example, ribs 126 may lift articles disposed in wash basket 122 during rotation of wash basket 122.

Washing machine appliance 100 includes a drive assembly 128 which is coupled to wash tub 120 and is generally configured for rotating wash basket 122 during operation, e.g., such as during an agitation or spin cycle. More specifically, as best illustrated in FIG. 2, drive assembly 128 may include a motor assembly 130 that is in mechanical communication with wash basket 122 to selectively rotate wash basket 122 (e.g., during an agitation or a rinse cycle of washing machine appliance 100). According to the illustrated embodiment, motor assembly 130 is a pancake motor. However, it should be appreciated that any suitable type, size, or configuration of motors may be used to rotate wash basket 122 according to alternative embodiments. In addition, drive assembly 128 may include any other suitable number, types, and configurations of support bearings or drive mechanisms.

Referring generally to FIGS. 1 and 2, cabinet 102 also includes a front panel 140 that defines an opening 142 that permits user access to wash basket 122. More specifically, washing machine appliance 100 includes a door 144 that is positioned over opening 142 and is rotatably mounted to front panel 140 (e.g., about a door axis that is substantially parallel to the vertical direction V). In this manner, door 144 permits selective access to opening 142 by being movable between an open position (not shown) facilitating access to a wash tub 120 and a closed position (FIG. 1) prohibiting access to wash tub 120. A gasket 200 may be provided in the opening 142 and the gasket 200 may sealingly engage the door 144 when the door 144 is in the closed position. For example, the gasket 200 may extend between the tub 120 and the front panel 140, e.g., generally along the transverse direction T and may extend about or around the opening 142 such that the gasket 200 is covered by the door 144 when the door 144 is in the closed position, and the gasket 200 may promote sealing between the door 144 and the cabinet 102, e.g., the front panel 140 of the cabinet 102.

In some embodiments, a window 146 in door 144 permits viewing of wash basket 122 when door 144 is in the closed position (e.g., during operation of washing machine appliance 100). Door 144 also includes a handle (not shown) that, for example, a user may pull when opening and closing door 144. Further, although door 144 is illustrated as mounted to front panel 140, it should be appreciated that door 144 may be mounted to another side of cabinet 102 or any other suitable support according to alternative embodiments.

Referring again to FIG. 2, wash basket 122 also defines a plurality of perforations 152 in order to facilitate fluid communication between an interior of basket 122 and wash tub 120. A sump 154 is defined by wash tub 120 at a bottom of wash tub 120 along the vertical direction V. Thus, sump 154 is configured for receipt of, and generally collects, wash fluid during operation of washing machine appliance 100. For example, during operation of washing machine appliance 100, wash fluid may be urged (e.g., by gravity) from basket 122 to sump 154 through the plurality of perforations 152. A pump assembly 156 is located beneath wash tub 120 for gravity assisted flow when draining wash tub 120 (e.g., via a drain 158). Pump assembly 156 is also configured for recirculating wash fluid within wash tub 120.

Referring still to FIGS. 1 and 2, in some embodiments, washing machine appliance 100 may include an additive dispenser or spout 170. For example, spout 170 may be in fluid communication with a water supply (not shown) in order to direct fluid (e.g., clean water) into wash tub 120. Spout 170 may also be in fluid communication with the sump 154. For example, pump assembly 156 may direct wash fluid disposed in sump 154 to spout 170 in order to circulate wash fluid in wash tub 120.

As illustrated, a detergent drawer 172 may be slidably mounted within front panel 140. Detergent drawer 172 receives a wash additive (e.g., detergent, fabric softener, bleach, or any other suitable liquid or powder) and directs the fluid additive to wash chamber 124 during operation of washing machine appliance 100. According to the illustrated embodiment, detergent drawer 172 may also be fluidly coupled to spout 170 to facilitate the complete and accurate dispensing of wash additive.

In some embodiments, an optional bulk reservoir 174 may be disposed within cabinet 102. Bulk reservoir 174 may be configured for receipt of fluid additive for use during operation of washing machine appliance 100. Moreover, bulk reservoir 174 may be sized such that a volume of fluid additive sufficient for a plurality or multitude of wash cycles of washing machine appliance 100 (e.g., five, ten, twenty, fifty, or any other suitable number of wash cycles) may fill bulk reservoir 174. Thus, for example, a user can fill bulk reservoir 174 with fluid additive and operate washing machine appliance 100 for a plurality of wash cycles without refilling bulk reservoir 174 with fluid additive. A reservoir pump 176 may be configured for selective delivery of the fluid additive from bulk reservoir 174 to wash tub 120.

A control panel 180 including a plurality of input selectors 182 may be coupled to front panel 140. Control panel 180 and input selectors 182 collectively form a user interface input for operator selection of machine cycles and features. A display 184 of control panel 180 indicates selected features, operation mode, a countdown timer, and/or other items of interest to appliance users regarding operation.

Operation of washing machine appliance 100 is controlled by a processing device or a controller 186 that is operatively coupled to control panel 180 for user manipulation to select washing machine cycles and features. In response to user manipulation of control panel 180, controller 186 operates the various components of washing machine appliance 100 to execute selected machine cycles and features. Controller 186 may include a memory and one or more microprocessors, CPUs or the like, such as general or special purpose microprocessors operable to execute programming instructions or micro-control code associated with operation of the appliance. The memory may represent one or more memory elements, e.g., random access memory such as DRAM, or read only memory such as ROM or FLASH, or electrically erasable, programmable read only memory (EEPROM). In one embodiment, the processor executes programming instructions stored in memory. The memory may be a separate component from the processor or may be included onboard within the processor. Alternatively, controller 186 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 180 may be in communication with controller 186 via one or more signal lines or shared communication busses to provide signals to and/or receive signals from the controller 186.

As used herein, “processing device” or “controller” may refer to one or more microprocessors, microcontroller, ASICS, or semiconductor devices and is not restricted necessarily to a single element. The controller 186 may be programmed to operate washing machine appliance 100 by executing instructions stored in memory (e.g., non-transitory media). The control panel 180 and the input selectors 182 may be in communication with the controller 186 via, for example, one or more signal lines or shared communication busses. Input/output (“I/O”) signals may be routed between controller 186 and various operational components of the appliance.

As mentioned above, the controller 186 may be programmed to operate the washing machine appliance 100 by executing instructions stored in memory. For example, the instructions may be software or any set of instructions that when executed by the processing device, cause the processing device to perform operations. Controller 186 can include one or more processor(s) and associated memory device(s) configured to perform a variety of computer-implemented functions and/or instructions (e.g., performing the methods, steps, calculations and the like and storing relevant data as disclosed herein). Controller 186 may include a network interface such that controller 186 can connect to and communicate over one or more networks with one or more network nodes. Controller 186 can also include one or more transmitting, receiving, and/or transceiving components for transmitting/receiving communications with other devices communicatively coupled with washing machine appliance 100. Additionally or alternatively, one or more transmitting, receiving, and/or transceiving components can be located off board controller 186. It should be noted that controllers 186 as disclosed herein are capable of and may be operable to perform any methods and associated method steps as disclosed herein. For example, in some embodiments, methods disclosed herein may be embodied in programming instructions stored in the memory and executed by the controller 186.

In exemplary embodiments, during operation of washing machine appliance 100, laundry items are loaded into wash basket 122 through opening 142, and a wash operation is initiated through operator manipulation of input selectors 182. For example, a wash cycle may be initiated such that wash tub 120 is filled with water, detergent, or other fluid additives (e.g., via detergent drawer 172 or bulk reservoir 174). One or more valves (not shown) can be controlled by washing machine appliance 100 to provide for filling wash basket 122 to the appropriate level for the amount of articles being washed or rinsed. By way of example, once wash basket 122 is properly filled with fluid, the contents of wash basket 122 can be agitated (e.g., with ribs 126) for an agitation phase of laundry items in wash basket 122. During the agitation phase, the basket 122 may be motivated about the axis of rotation AR at a set speed (e.g., first speed or tumble speed). As the basket 122 is rotated, articles within the basket 122 may be lifted and permitted to drop therein.

After the agitation phase of the washing operation is completed, wash tub 120 can be drained, e.g., by drain pump assembly 156. Laundry articles can then be rinsed (e.g., through a rinse cycle) by again adding fluid to wash tub 120, depending on the particulars of the cleaning cycle selected by a user. Ribs 126 may again provide agitation within wash basket 122. One or more spin cycles may also be used. In particular, a spin cycle may be applied after the wash cycle or after the rinse cycle in order to wring wash fluid from the articles being washed. During a spin cycle, basket 122 is rotated at relatively high speeds. For instance, basket 122 may be rotated at one set speed (e.g., second speed or pre-plaster speed) before being rotated at another set speed (e.g., third speed or plaster speed). As would be understood, the pre-plaster speed may be greater than the tumble speed and the plaster speed may be greater than the pre-plaster speed. Moreover, agitation or tumbling of articles may be reduced as basket 122 increases its rotational velocity such that the plaster speed maintains the articles at a generally fixed position relative to basket 122. After articles disposed in wash basket 122 are cleaned (or the washing operation otherwise ends), a user can remove the articles from wash basket 122 (e.g., by opening door 144 and reaching into wash basket 122 through opening 142).

During such operations, a gasket 200 may help to contain wash fluid within the cabinet 102, particularly within the tub 120. As generally shown in FIG. 2, the gasket 200 may be positioned between the door 144 and the tub 120, e.g., when the door 144 is in the closed position as in FIG. 2. Thus, the gasket 200 may sealingly engage the door 144 when the door 144 is in the closed position. In general, the gasket 200 sealingly engages the cabinet 102, in particular the opening 142 thereof, the tub 120, and the door 144. For example, the gasket 200 may extend around the opening 142 along a circumferential direction and may extend between the cabinet 102 and the wash tub 120 along an axial direction.

As will be described in more detail below, washing machine appliance 100 may further include features that are generally configured to permit inspection of the gasket 200. More specifically, such features may include one or more camera assemblies such as camera 192, and/or other detection devices.

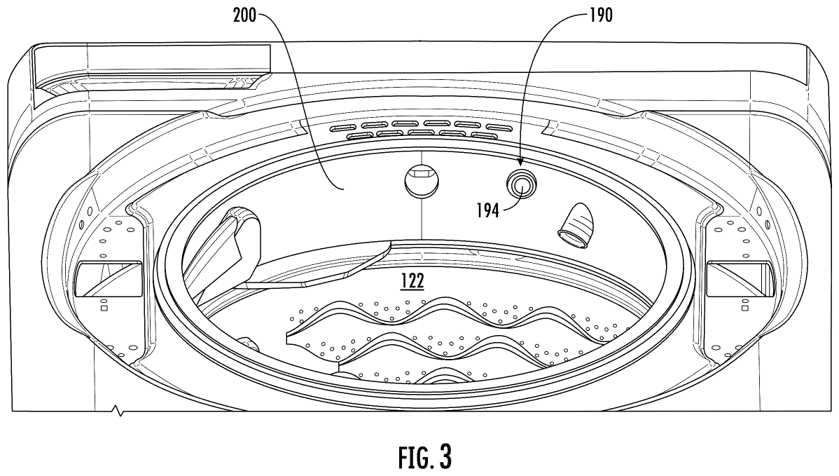

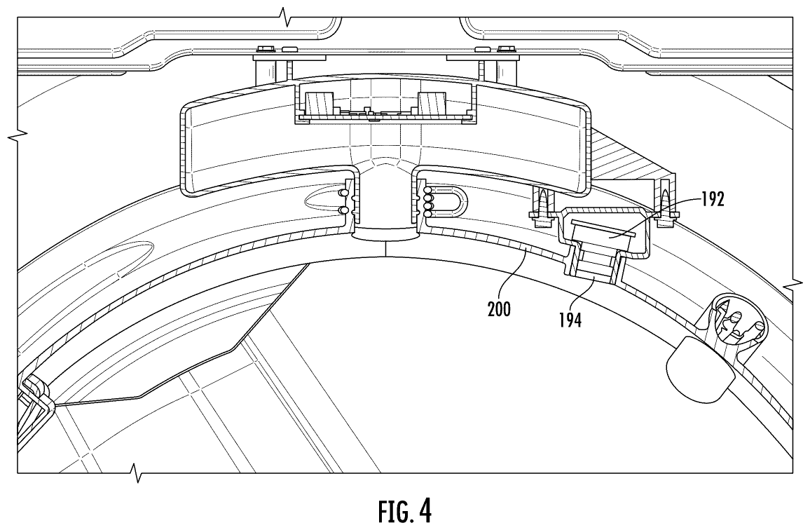

As shown, e.g., in FIGS. 3 and 4, the washing machine appliance may include a camera assembly 190 including camera 192, which is generally positioned and configured for obtaining images of the gasket 200, during operation of the camera assembly 190 e.g., oriented to have a field of vision or field of view directed towards at least a portion of the gasket 200. In some exemplary embodiments, camera assembly 190 may include more than one camera 192.

Specifically, according to the illustrated embodiment, door 144 of washing machine appliance 100 comprises window 146. According to the illustrated exemplary embodiment, camera assembly 190 includes a camera 192 that is mounted to inboard of door 144 and window 146. Specifically, camera 192 is mounted such that it faces toward a bottom portion of gasket 200 inboard of the door 144. In this manner, camera 192 can take images or video of gasket 200 and remains unobstructed by windows, e.g., window 146, that may obscure or distort such images.

Referring still to FIGS. 3 and 4, installation of camera assembly 190 will be described according to an exemplary embodiment of the present subject matter. According to this exemplary embodiment, camera assembly 190 includes a camera 192 mounted within gasket 200, where gasket 200 is positioned between the front panel 140 of cabinet 102 and the door 144 (e.g., when the door 144 is in the closed position). In some embodiments, e.g., as illustrated in FIG. 4, camera assembly 190 may include a lens 194 that is constructed from a clear hydrophobic material or camera 192 may otherwise be positioned behind a hydrophobic clear lens. So positioned, camera assembly 190 may obtain one or more images or videos of gasket 200 (or other objects, e.g., which may be entrapped within or entangled with the gasket 200, as described in more detail below).

Washing machine appliance 100 may further include a light that is positioned within cabinet 102, such as within wash chamber 124 for selectively illuminating at least a portion of the interior of the cabinet 102 and any contents positioned therein. Although exemplary camera assemblies 190 are illustrated and described herein, it should be appreciated that according to alternative embodiments, washing machine appliance 100 may include any other camera or system of imaging devices for obtaining images within and around the appliance.

In embodiments where camera assembly 190 includes a plurality of cameras, each of the plurality of cameras may have a specified monitoring zone or range positioned in and/or around washing machine appliance 100, such as multiple cameras oriented in or facing various directions. In this regard, for example, the field of view of each camera may be limited to or focused on a specific area. As such, each camera may be positioned and oriented to monitor one or more areas of the washing machine appliance 100, such as various portions of the gasket 200. It should be appreciated that according to alternative embodiments, camera assembly 190 may include any suitable number, type, size, and configuration of camera(s) for obtaining images of any suitable areas or regions within washing machine appliance 100. In addition, it should be appreciated that each camera may include features for adjusting the field of view and/or orientation.

It should be appreciated that the images obtained by camera assembly 190 may vary in number, frequency, angle, resolution, detail, etc. in order to improve the clarity of the particular regions surrounding or within washing machine appliance 100. In addition, according to exemplary embodiments, controller 186 may be configured for illuminating the washing machine appliance 100 and/or surrounding areas using one or more light sources prior to obtaining images. Notably, controller 186 of washing machine appliance 100 (or any other suitable dedicated controller) may be communicatively coupled to camera assembly 190 and may be programmed or configured for analyzing and/or processing the images obtained by camera assembly 190.

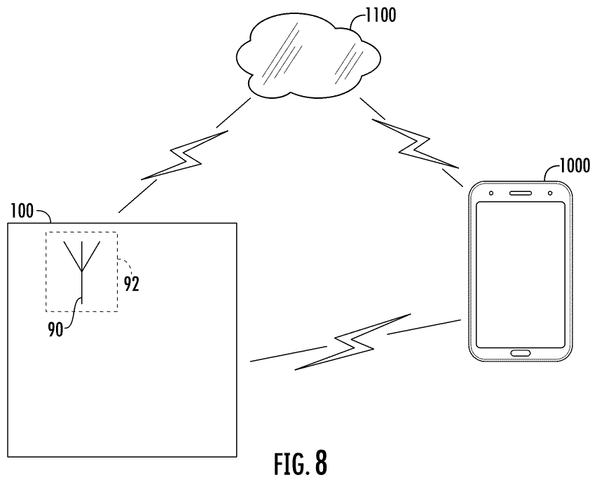

In general, controller 186 may be operably coupled to camera assembly 190 for analyzing, manipulating, synthesizing and/or otherwise processing one or more images obtained by camera assembly 190 to extract useful information regarding objects within the field of view of the one or more cameras. Notably, such processing may be performed locally (e.g., on controller 186) or the images may be transmitted to a remote server (e.g., in the “cloud,” as those of ordinary skill in the art will recognize as referring to a remote server or database in a distributed computing environment including at least one remote computing device, e.g., as described below with reference to FIG. 8) for analysis, processing, etc.

Notably, controller 186 of washing machine appliance 100 (or any other suitable dedicated controller) may be communicatively coupled to camera assembly 190, a light, and other components of washing machine appliance 100. As explained in more detail below, controller 186 may be programmed or configured for obtaining one or images within washing machine appliance 100, transmitting those images to a remote device (e.g., such as a user's mobile phone 1000, e.g., as noted in FIG. 8), receiving feedback from the user's remote device (e.g., as a cycle authorization or parameter adjustment), and implementing responsive action based on that user input for improved performance and safety of operation.

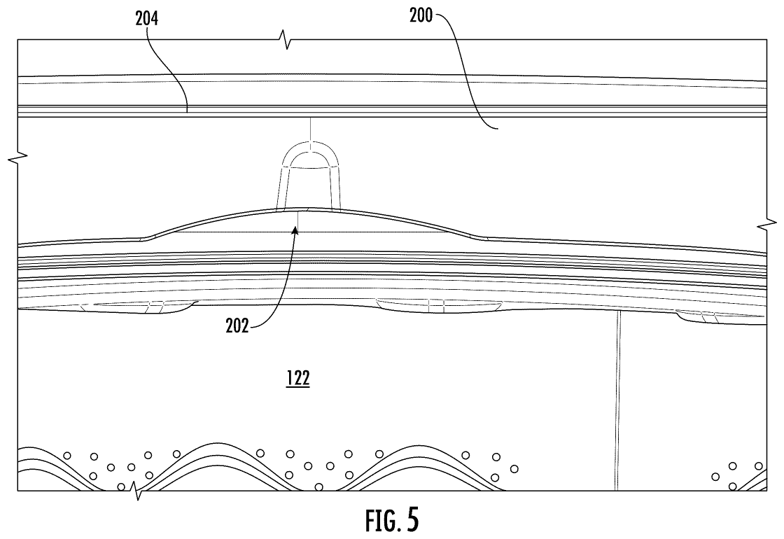

An exemplary image that may be captured or obtained using the camera assembly 190 is illustrated in FIG. 5. As may be seen, e.g., in FIG. 5, the image may include a portion of the gasket 200, such as a bottom central portion of the gasket 200. For example, the gasket 200 may include a drain 202 and the drain 202 may be included within the field of view of the camera 192, such as the camera 192 may be positioned and oriented towards the drain 202 in the gasket 200 such that the drain 202 is included within the field of view of the camera 192. Images obtained by or with the camera 192 may thereby include the drain 202 of the gasket 200, such as to promote detection of foreign objects which may clog or obstruct the drain 202. The gasket 200 may further include a lip 204, e.g., at a frontmost edge of the gasket 200, which is configured to sealingly engage an inner surface of the door 144 and/or window 146 when the door 144 (which is not shown in FIG. 5) is in the closed position. At least a portion of the lip 204 of the gasket 200 may be included in the field of view of the camera 192, such as to promote detection of foreign objects at, around, and/or across the lip 204, which may interrupt or break sealing engagement of the gasket 200 with the door 144 when the door is in the closed position.

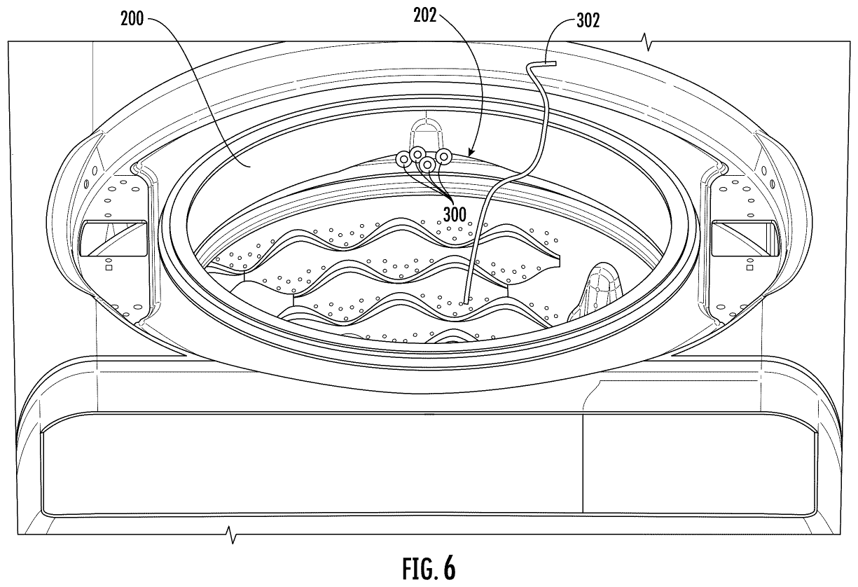

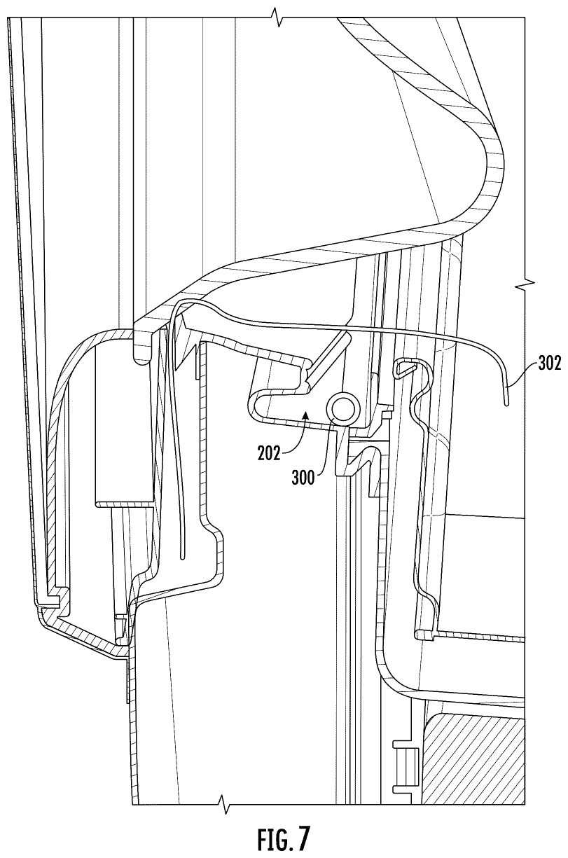

Turning now to FIGS. 6 and 7, illustrated are exemplary foreign objects which may be detected in or on the gasket 200. For example, one or more smaller foreign objects 300, such as coins or buttons, may be detected in and/or around the gasket drain 202. As another example, one or more elongated foreign objects 302, such as a shoe lace or a sock, may be detected at or around the lip 204, such as extending across the lip 204. As mentioned, the presence of such foreign objects may impede the functionality of the gasket 200, such as clogging the drain 202 and/or impairing sealing of the gasket 200 to the door 144 (including the window 146 of the door 144). Additionally, if one or more such foreign objects are present during operation of the washing machine appliance 100, the object(s) may be pulled out of the gasket 200 in a manner that results in damage, e.g., tearing, to the gasket 200.

Turning now to FIG. 8, a general schematic is provided of washing machine appliance 100, which communicates wirelessly with a remote user interface device 1000 and a network 1100. For example, as illustrated in FIG. 8, the washing machine appliance 100 may include an antenna 90 by which the washing machine appliance 100 communicates with, e.g., sends and receives signals to and from, the remote user interface device 1000 and/or network 1100. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The remote user interface device 1000 may be a laptop computer, smartphone, tablet, personal computer, wearable device, smart speaker, smart home system, and/or various other suitable devices. The communications module 92 may be onboard the controller 186 or may be a separate module.

The washing machine appliance 100 may be in communication with the remote user interface device 1000 device through various possible communication connections and interfaces. The washing machine appliance 100 and the remote user interface device 1000 may be matched in wireless communication, e.g., connected to the same wireless network. The washing machine appliance 100 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the washing machine appliance 100 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the washing machine appliance 100, e.g., the remote user interface device 1000 is a separate, stand-alone device from the washing machine appliance 100 which communicates with the washing machine appliance 100 wirelessly. Any suitable device separate from the washing machine appliance 100 that is configured to provide and/or receive communications, information, data, or commands from a user may serve as the remote user interface device 1000, such as a smartphone (e.g., as illustrated in FIG. 8), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 180. For example, the remote user interface device 1000 may be a smartphone operable to store and run applications, also known as “apps,” and the additional user interface may be provided as a smartphone app.

As mentioned above, the washing machine appliance 100 may also be configured to communicate wirelessly with a network 1100. The network 1100 may be, e.g., a cloud-based data storage system including one or more remote computing devices such as remote databases and/or remote servers, which may be collectively referred to as “the cloud” (or other distributed computing system, such as the fog or the edge). For example, the washing machine appliance 100 may communicate with the cloud 1100 over the Internet, which the washing machine appliance 100 may access via WI-FI®, such as from a WI-FI® access point in a user's home.

Exemplary methods for operating a washing machine appliance, such as the exemplary washing machine appliance 100 described above, are provided. In this regard, for example, a controller of the appliance, e.g., controller 186, may be configured for implementing some or all steps of one or more of the following exemplary methods. However, it should be appreciated that the exemplary methods are discussed herein only to describe exemplary aspects of the present subject matter, and are not intended to be limiting.

Notably, controller 186 of washing machine appliance 100 (or any other suitable dedicated controller) may be communicatively coupled to camera 192 and other components of washing machine appliance 100. As explained in more detail below, controller 186 may be programmed or configured for obtaining images using camera 192, e.g., in order to detect certain operating conditions and improve the performance of washing machine appliance 100. In addition, controller 186 may be programmed or configured to perform methods to identify objects on or in the gasket 200.

The image or images obtained by or with the camera 192, e.g., such as the example image illustrated in FIG. 5, may be analyzed to determine whether there is or are foreign objects (e.g., objects which are not part of the gasket 200 or otherwise part of the washing machine appliance 100) in or on the gasket 200, based at least in part on the one or more images, e.g., using an image processing algorithm and/or a machine learning image recognition process. Each of these image evaluation processes will be described below according to exemplary embodiments of the present subject matter. It should be appreciated that image processing and machine learning image recognition processes may be used together to provide an extra safety factor and redundant detection methods to improve the likelihood of detecting foreign objects. In some exemplary embodiments, such redundant or duplicative detection methods may be desirable to improve the likelihood of accurate detection and eliminate false negatives.

As used herein, the term “image processing algorithm” and the like is generally intended to refer to any suitable methods or algorithms for analyzing images, e.g., of gasket 200, that do not rely on artificial intelligence or machine learning techniques (e.g., in contrast to the machine learning image recognition process as described below). For example, the image processing algorithm may rely on image differentiation, e.g., such as a pixel-by-pixel comparison of two sequential images. Image differentiation may be used to, for example, determine if a geometric property, e.g., shape, area, or dimension, etc., of the gasket 200 changes, such as crosses a threshold, e.g., a minimum or maximum, which may indicate a presence of a foreign object, such as a bulge or other distortion of the gasket 200 caused by an entrapped foreign object therein, or such as a discontinuity in a line of contact or contact surface between the gasket 200 and, e.g., door 144. If there are substantial differences between the sequentially obtained images, this may indicate a presence of a foreign object in the washing machine appliance.

Additional embodiments may also include using a machine learning image recognition process instead of or in addition to an image processing algorithm. In this regard, the images obtained by camera 192 may be used by controller 186 for detecting foreign objects. In addition, it should be appreciated that this image analysis or processing may be performed locally (e.g., by controller 186) or remotely, such as by using distributed computing, a digital cloud, or a remote server. According to exemplary embodiments of the present subject matter, the images obtained with the camera 192 may be analyzed using a neural network classification module and/or a machine learning image recognition process. In this regard, for example, controller 186 may be programmed to implement the machine learning image recognition process that includes a neural network trained with a plurality of images of the gasket 200. By analyzing the images obtained by the camera 192 using this machine learning image recognition process, controller 186 may determine whether there is or are one or more foreign objects present in the washing machine appliance 100, such as in or on the gasket 200 thereof. According to exemplary embodiments, if one or more foreign object(s) is/are detected using either the image processing algorithm or the machine learning image recognition process (or both), responsive action may be implemented.

As used herein, the terms image recognition process and similar terms may be used generally to refer to any suitable method of observation, analysis, image decomposition, feature extraction, image classification, etc. of one or more images or videos taken within a washing machine appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by camera 192, and that controller 186 may be programmed to perform such processes and take corrective action.

According to an exemplary embodiment, controller may implement a form of image recognition called region-based convolutional neural network (“R-CNN”) image recognition. Generally speaking, R-CNN may include taking an input image and extracting region proposals that include a potential object, such as the gasket, the door, the basket, and/or a foreign object in, on, or near one or more of such components of the washing machine appliance. In this regard, a “region proposal” may be regions in an image that could belong to a particular object, such as a foreign object in or on the gasket. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN”and the like.

According to still other embodiments, the image recognition process may use any other suitable neural network process. For example, the image recognition process may include using Mask R-CNN instead of a regular R-CNN architecture. In this regard, Mask R-CNN is based on Fast R-CNN which is slightly different than R-CNN. In addition, a K-means algorithm may be used. Other image recognition processes are possible and within the scope of the present subject matter.

It should be appreciated that any other suitable image recognition process may be used while remaining within the scope of the present subject matter. For example, the image or images from the camera 192 may be analyzed using a deep belief network (“DBN”) image recognition process. A DBN image recognition process may generally include stacking many individual unsupervised networks that use each network's hidden layer as the input for the next layer. According to still other embodiments, the image or images from the camera 192 may be analyzed by the implementation of a deep neural network (“DNN”) image recognition process, which generally includes the use of a neural network (computing systems inspired by biological neural networks) with multiple layers between input and output. Other suitable image recognition processes, neural network processes, artificial intelligence (“AI”) analysis techniques, and combinations of the above described or other known methods may be used while remaining within the scope of the present subject matter.

Now that the construction of a washing machine appliance 100 and the configuration of controller 186 according to exemplary embodiments have been presented, exemplary methods of operating a household appliance will be described. In exemplary embodiments, the various method steps as disclosed herein may be performed by controller 186 or a separate, dedicated controller. Furthermore, some or all of the various method steps may be performed remotely, e.g., in a distributed computing environment such as the cloud, fog, or edge, wherein the controller 186 communicates with one or more remote computing devices of the distributed computing environment, such as processing, e.g., image analysis and/or process, may be performed in the cloud and the output of such process may be transmitted to and received by the washing machine appliance 100, such as by the controller 186 thereof via the communications module 92.

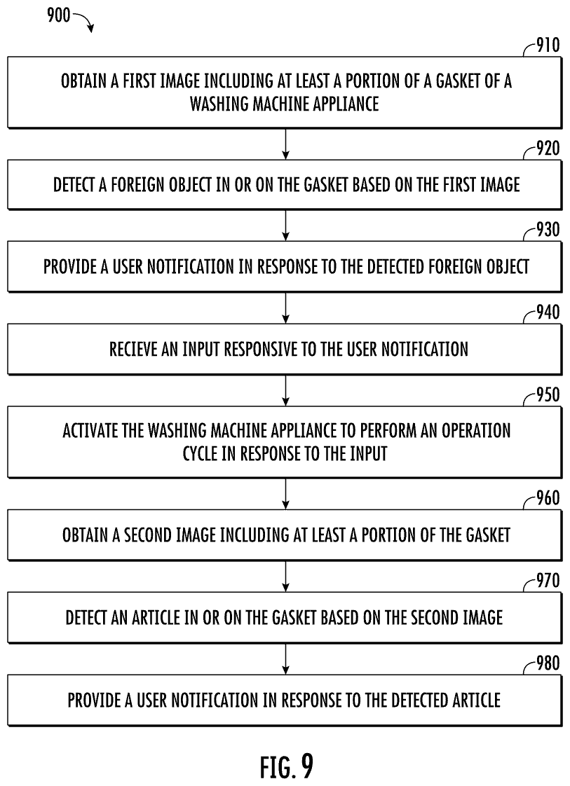

An exemplary method 900 of operating a washing machine appliance is illustrated in FIG. 9. The washing machine appliance may include a camera assembly operable to obtain an image. As shown in FIG. 9, method 900 may include (910) obtaining a first image. The first image may be obtained by or from the camera assembly. The image may be an image of a gasket of the washing machine appliance, such as the image may include at least a portion of the gasket. The first image may, in some embodiments, be one of a first plurality of images.

Method 900 may also include (920) detecting a foreign object in or on the gasket based on the obtained image, such as at least one foreign object. For example, the foreign object may be any object which is not a component of the washing machine appliance, such as an article, e.g., a clothing article such as a sock, or contents such as loose items which may be found in or intermingled with clothing articles, e.g., a coin from a pocket, a pen, a crayon, etc., or a button or other fastener or element which may have detached from a clothing article, among numerous other possible exemplary foreign objects which may be detected. The foreign object, or objects, that are detected may be in contact with the gasket, such as on top of or lying across the gasket and/or in the gasket, e.g., at least partially enclosed within a fold or folds of the gasket. In particular, the foreign object, or objects, that are detected may be in contact with gasket at one or more specific areas or portions of the gasket, such as a drain or gutter of the gasket (e.g., which may indicate the foreign object(s) potentially interfering with the drainage of the gasket) or an outer forward periphery of the gasket (e.g., which my indicate the foreign object(s) potentially impeding sealing engagement of the gasket with the door/window).

Method 900 may further include (930) providing a user notification in response to the detected foreign object. The user notification may be provided on a user interface of the washing machine appliance, such as a local interface of the washing machine appliance, e.g., display 184, and/or a remote interface, e.g., on a screen of a remote user interface device such as the smartphone (remote user interface device 1000) illustrated in FIG. 8.

Method 900 may also include (940) receiving an input responsive to the user notification. The input may be received, e.g., via the user interface of the washing machine appliance, such as the same user interface by which the user notification was provided, or another user interface, such as the notification may be provided on a remote user interface and the responsive input may be received via a local interface, or vice versa, among other possible combinations of interfaces.

As illustrated in FIG. 9, embodiments of method 900 may also include (950), activating the washing machine appliance in response to the input. In such embodiments, activating the washing machine appliance includes performing an operation cycle of the washing machine appliance. For example, the user may be prompted to remove or relocate the foreign object(s) from the gasket by the user notification (e.g., which is provided at 930, as described above). After doing so, the user may then provide the responsive input (e.g., as described above at 940) to indicate that the gasket is now clear and it is safe to proceed with the operation of the washing machine appliance. Thus, methods according to the present disclosure such as method 900 may prevent or reduce instances of damage to the gasket by foreign objects and/or impaired functionality of the gasket due to the presence of foreign objects.

Activating the appliance, e.g., in (950) of method 900, includes causing at least one mechanical component of the appliance to be operated. For example, the mechanical component may be a motor, such as the motor 130 of the washing machine appliance, a pump, or a valve, among other possible example mechanical components of a washing machine appliance. Also, operating the mechanical component includes changing a physical status of the component, e.g., a speed, position, etc. of the component, such as accelerating the motor, e.g., from a zero starting speed, opening a valve, and/or other changes in the physical state of one or more mechanical components of the washing machine appliance. Thus, it is to be understood that the washing machine appliance may also include a mechanical component, and methods according to the present disclosure may further include activating the mechanical component.

Still referring to FIG. 9, method 900 may also include (960) obtaining a second image after performing the operation cycle of the washing machine appliance. The second image (which may, in some embodiments, be one of a second plurality of images, e.g., as discussed below) may include the at least portion of the gasket, e.g., the same portion of the gasket as the first image, such as at least the gasket drain and the sealing periphery of the gasket. For example, the second image may be obtained using the same camera as the first image, with the camera in the same position and configuration to obtain multiple images with the same field of view, e.g., including the at least portion of the gasket.

Method 900 may further include (970) detecting an article, e.g., one or more articles, in or on the gasket based on the second image. The one or more articles may be, for example, one or more of the articles which were treated during the operation cycle of the washing machine appliance.

Method 900 may also include (980) providing a user notification in response to the detected article. The user notification at (980) may be similar to the user notification described above with reference to (930). For example, the user notification may be provided on a user interface of the washing machine appliance, such as a local user interface and/or remote user interface, e.g., as described above.

FIG. 9 depicts steps performed in a particular order for purposes of illustration and discussion. Those of ordinary skill in the art, using the disclosures provided herein, will understand that (except as otherwise indicated) the steps of the method 900 can be modified, adapted, rearranged, omitted, interchanged, or expanded in various ways without deviating from the scope of the present disclosure.

In additional embodiments, methods according to the present disclosure may be performed before or after an operation cycle of the washing machine appliance. For example, in some embodiment the image-based check for foreign objects in or on the gasket may be performed only immediately before the operation cycle, only immediately after the operation cycle, or both. For example, the image-based object detection may be performed immediately before the operation cycle, such as in response to a start command for a selected operation cycle and before actually starting the selected operation cycle. As another example, the image-based object detection may be performed immediately after the operation cycle, such as in response to detecting a door opening after completing the operation cycle or otherwise in response to determining an operation cycle has ended. In a further example, the door opening may indicate the beginning of a cycle, e.g., the door may be opened to load articles into the washing machine appliance, or the door opening may indicate the end of a cycle, e.g., the door may be opened to unload articles from the washing machine appliance after a cycle. Thus, the camera may be operated to obtain an image in response to any door opening, and the door opening may be detected at the beginning or at the end of a cycle, such as based on whether the door opening is detected within a time threshold after completing a previous or recent cycle (e.g., a door opening shortly after a cycle being considered at the end of that cycle, whereas when the door opening is detected more than the time threshold after the operation, such operation would be considered a previous operation and the door opening would be at the beginning of a current operation).

For example, in some embodiments, methods according to the present disclosure may include performing an operation cycle of the washing machine appliance, where the operation cycle includes treating one or more articles in a wash chamber of the washing machine appliance. Such embodiments may also include obtaining an image with the camera assembly after performing the operation cycle. The image may include at least a portion of the gasket. The image may be a single image or may be one of a plurality of images obtained with the camera assembly. Such methods may further include detecting one of the articles in or on the gasket based on the obtained image and providing a user notification on a user interface of the washing machine appliance in response to the detected article.

In such embodiments, the image may be a first image. Such embodiments may further include obtaining a second image before performing the operation cycle of the washing machine appliance. The second image may include the at least portion of the gasket. Such embodiments may further include detecting a foreign object in or on the gasket based on the second image and providing a user notification on the user interface of the washing machine appliance in response to the detected foreign object. and receiving an input via the user interface of the washing machine appliance, the input responsive to the user notification, wherein the operation cycle is performed in response to the input.

Detecting one of the articles in or on the gasket based on the obtained image may include analyzing the obtained image at least in part by a controller of the washing machine appliance. For example, the controller of the washing machine appliance may be in communication with one or more remote computing devices, such as in the cloud, and the image analysis may be performed in part by the controller onboard the washing machine appliance and in part by the remote computing device(s), such as the controller may transmit the image or images to the remote computing device(s) and the controller may receive results of the analysis, such as an indication of a detected foreign object, e.g., article, from the remote computing device(s).

In some embodiments, exemplary methods according to the present disclosure may include disabling the washing machine appliance in response to detecting one of the articles in or on the gasket. For example, disabling the washing machine appliance may prevent or reduce damage to the gasket or other impairments of the washing machine appliance operation caused by foreign objects on or in the gasket during operation of the washing machine appliance. Such methods may also include receiving an input via the user interface of the washing machine appliance, the input responsive to the user notification, and enabling the washing machine appliance based on the input. As noted above, the user notification may include an instruction to remove the foreign object(s) from the gasket, and the responsive input may indicate that such foreign object(s) have been removed.

For example, the washing machine appliance may be locked by disabling one or more controls of the washing machine, such as disabling one or more (up to and including all) of the input selectors 182 on the control panel 180, for example, the input selector(s) may be unavailable or unresponsive when the washing machine appliance is locked, such that an operation cycle of the washing machine appliance cannot be initiated while the washing machine appliance is locked. Additionally, locking the washing machine appliance may also or instead include disabling controls provided on a remote user interface device, e.g., touch controls on a smartphone.

In additional exemplary embodiments, methods according to the present disclosure may include obtaining an image with the camera assembly, e.g., before activating the washing machine appliance, where the washing machine appliance may be activated after one or more responsive actions based on the image (such as when analysis of the image indicate the presence of a foreign object in contact with the gasket). The image may include at least a portion of the gasket. Such methods may also include detecting a foreign object in or on the gasket based on the obtained image. A user notification may be provided, e.g., on a local user interface or a remote user interface of the washing machine appliance, in response to the detected foreign object. Such embodiments may further include receiving an input responsive to the user notification, such as via the local and/or remote user interface of the washing machine appliance. In such embodiments, the washing machine appliance may be activated, which includes performing an operation cycle of the washing machine appliance, in response to the input.

In such embodiments, the image may be the only image or one of a plurality of images obtained at the same time. In additional embodiments, a second image at a different time, or a plurality of second images at the different time, may be obtained. Each such image in the various aforementioned embodiments generally includes the same field of vision, e.g., each such image includes the at least portion of the gasket.

The operation cycle may include treating one or more articles in a wash chamber of the washing machine appliance. Such embodiments may further include detecting, based on the second image, at least one of the one or more articles in or on the gasket.

For example, such methods may include detecting an opening of the door after performing the operation cycle, and the second image may be obtained after detecting the opening of the door. The second image may be one of a plurality of images obtained with the camera assembly. The plurality of images may be obtained after detecting the opening of the door and before detecting a closing of the door.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a washing machine appliance, the washing machine appliance comprising a cabinet, a door rotatably mounted to the cabinet, a gasket, and a camera assembly, the method comprising:
performing an operation cycle of the washing machine appliance, the operation cycle comprising treating one or more articles in a wash chamber of the washing machine appliance;
obtaining an image with the camera assembly after performing the operation cycle, the image including at least a portion of the gasket;
detecting one of the articles in or on the gasket based on the obtained image; and
providing a user notification on a user interface of the washing machine appliance in response to the detected article.

2. The method of claim 1, wherein the image is a first image, further comprising obtaining a second image before performing the operation cycle of the washing machine appliance, the second image including the at least portion of the gasket.

3. The method of claim 2, further comprising detecting a foreign object in or on the gasket based on the second image, providing a user notification on the user interface of the washing machine appliance in response to the detected foreign object, and receiving an input via the user interface of the washing machine appliance, the input responsive to the user notification, wherein the operation cycle is performed in response to the input.

4. The method of claim 1, wherein detecting one of the articles in or on the gasket based on the obtained image comprises analyzing the obtained image at least in part by a controller of the washing machine appliance.

5. The method of claim 1, wherein the image is one of a plurality of images obtained with the camera assembly.

6. The method of claim 1, further comprising detecting an opening of the door after performing the operation cycle, wherein the image is obtained after detecting the opening of the door.

7. The method of claim 6, wherein the image is one of a plurality of images obtained with the camera assembly, and wherein the plurality of images are obtained after detecting the opening of the door and before detecting a closing of the door.

8. The method of claim 1, further comprising disabling the washing machine appliance in response to detecting one of the articles in or on the gasket, receiving an input via the user interface of the washing machine appliance, the input responsive to the user notification, and enabling the washing machine appliance based on the input.

9. A method of operating a washing machine appliance, the washing machine appliance comprising a cabinet, a door rotatably mounted to the cabinet, a gasket, and a camera assembly, the method comprising:
obtaining an image with the camera assembly, the image including at least a portion of the gasket;
detecting a foreign object in or on the gasket based on the obtained image;
providing a user notification on a user interface of the washing machine appliance in response to the detected foreign object;
receiving an input via the user interface of the washing machine appliance, the input responsive to the user notification; and
activating the washing machine appliance in response to the input, wherein activating the washing machine appliance comprises performing an operation cycle of the washing machine appliance.

10. The method of claim 9, wherein the image is a first image, further comprising obtaining a second image after performing the operation cycle of the washing machine appliance, the second image including the at least portion of the gasket.

11. The method of claim 10, wherein the operation cycle comprises treating one or more articles in a wash chamber of the washing machine appliance, further comprising detecting, based on the second image, at least one of the one or more articles in or on the gasket.

12. The method of claim 10, further comprising detecting an opening of the door after performing the operation cycle, wherein the second image is obtained after detecting the opening of the door.

13. The method of claim 12, wherein the second image is one of a plurality of images obtained with the camera assembly, and wherein the plurality of images are obtained after detecting the opening of the door and before detecting a closing of the door.

14. The method of claim 9, wherein detecting the foreign object in or on the gasket based on the obtained image comprises analyzing the obtained image at least in part by a controller of the washing machine appliance.

15. The method of claim 9, wherein the image is one of a plurality of images obtained with the camera assembly.

16. The method of claim 9, further comprising disabling the washing machine appliance in response to detecting the foreign object in or on the gasket, receiving an input via the user interface of the washing machine appliance, the input responsive to the user notification, and enabling the washing machine appliance based on the input.

17. A washing machine appliance, comprising:
a cabinet;
a door rotatably mounted to the cabinet;
a gasket;
a camera assembly; and
a controller, the controller configured for:
performing an operation cycle of the washing machine appliance, the operation cycle comprising treating one or more articles in a wash chamber of the washing machine appliance;
obtaining an image with the camera assembly after performing the operation cycle, the image including at least a portion of the gasket;
detecting one of the articles in or on the gasket based on the obtained image; and
providing a user notification on a user interface of the washing machine appliance in response to the detected article.

18. The washing machine appliance of claim 17, wherein the image is a first image, wherein the controller is further configured for obtaining a second image before performing the operation cycle of the washing machine appliance, the second image including the at least portion of the gasket.

19. The washing machine appliance of claim 18, wherein the controller is further configured for detecting a foreign object in or on the gasket based on the second image, providing a user notification on the user interface of the washing machine appliance in response to the detected foreign object, and receiving an input via the user interface of the washing machine appliance, the input responsive to the user notification, wherein the operation cycle is performed in response to the input.
